(19) United States
(12) Patent Application Publication
(10) Pub. No.: US 2005/0102191 A1
(43) Pub. Date: May 12, 2005

(54) Method for retailing electronic media

(76) Inventor: Andrew R. Heller, Austin, TX (US)

Correspondence Address: Kelly K. Kordzik;Winstead Sechrest & Minick P.C., P.O. Box 50784, 1201 Main Street, Dallas, TX, 75250-0784, US

(21) Appl. No.: 10/703,350

(22) Filed: Nov. 7, 2003

(51) Int. Cl. G06F 17/60

(52) U.S. Cl. 705/26

(57) ABSTRACT

The present invention is directed to a unique method of retailing electronic multimedia in a controlled environment, and to a system which enables such a retailing method. Such an environment is generated by requiring the creation of portable and/or hard copies of such multimedia files to be generated only in specific retail locations. Such retail locations would physically contain no pre-recorded media files. Rather, they would comprise one or more local servers located in the retail locations and connected via a network to one or more remote sources. Such remote sources may comprise servers, libraries, databases, and the like. While no pre-recorded electronic media is stored on the local server, it can be downloaded and held in a cache on the local server. From the local server, the media can be saved onto a portable storage medium. Eliminating local storage of the electronic media files increases control over their distribution and maximizes distribution efficiency.

### TECHNICAL FIELD

The present invention relates in general to the retailing of various forms of media, and in particular to a method of retailing electronic media, wherein the content of the media is maintained in digitized format.

### BACKGROUND INFORMATION

Media such as music, images, movies, books, magazines, games, etc. are all available in electronic format. A variety of file formats have emerged in which such media can be stored (mp3, mpeg, pdf, etc.) as well as the associated readers/viewers which can read/view one or more of these file formats. Some of these readers/viewers comprise dedicated hardware (e.g., DVD players, CD-ROM, DataPlay™, portable mp3 players, etc.), whereas other readers/viewers are software programs which are often run on personal computers (e.g., RealPlayer™, Windows Media® Player, etc.).

The growth of the Internet has allowed such electronic multimedia files to be shared and distributed (often illegally) worldwide. Because of the ubiquity of such file formats, and their associated viewers, players, etc., there exists a tremendous market for the legal, controlled sale and distribution of such multimedia products, especially when such files contain copyrighted media. While there exist a number of methods for purchasing copyrighted downloadable media files from Internet vendors (e.g., iTunes and U.S. Pat. Nos. 6,460,076 and 6,512,778) wherein files are downloaded over the Internet to a personal computer at customer's home or business, applicant is unaware of any existing methods for downloading such files for sale utilizing a traditional retail venue.

### SUMMARY OF THE INVENTION

The present invention is directed to a unique method of retailing electronic multimedia in a controlled environment, and to a system which enables such a retailing method. Such an environment is generated by requiring the creation of portable and/or hard copies of such multimedia files to be generated only in specific retail locations. Such retail locations would physically contain no pre-recorded media files. Rather, they would comprise one or more local servers located in the retail locations and connected via a network to one or more remote sources. Such remote sources may comprise servers, libraries, databases, and the like. While no pre-recorded electronic media is stored on the local server, it can be downloaded and held in a cache on the local server. From the local server, the media can be saved onto a portable storage medium. Eliminating local storage of the electronic media files increases control over their distribution, and maximizes distribution efficiency.

In general terms, the retailing method of the present invention comprises a number of steps whereby a customer selects desired media files, customer purchases media files at some point after having selected them, selected files are downloaded from a remote source to a local server in a traditional retail venue, and selected files are saved on a storage medium and delivered to the customer as a product.

A system is required to enable such a method as that described above. Such a system generally comprises a local server/controller housed at or within the retail outlet and connected to remote file sources via a network. Such a local server/controller comprises the hardware and software necessary to search, locate, and retrieve electronic media files, as well as storage, caching, communication interfaces, transaction controls, error and recovery controls, and the like. Connected to, and controlled by, the local server/controller are a number of subsystem processing devices capable of generating and delivering a consumer product in accordance with the present invention.

The foregoing has outlined rather broadly the features of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 schematically illustrates a method for retailing electronic media within traditional retail venues;

FIG. 2 illustrates a system with which electronic media can be distributed to retail outlets for sale;

FIG. 3 illustrates the various subsystem processing devices which can be employed in the enabling device to generate media products in accordance with the present invention;

FIG. 4 schematically illustrates a method by which a computer program controls the identification, selection, and manipulation of electronic media files:

FIG. 5 illustrates how an enabling device comprising the local server/controller and the various subsystem processing devices can be used to automate the processes of the present invention;

FIG. 6 illustrates further how the various subsystem processing devices can be integrated into an automated enabling device;

FIG. 7 schematically illustrates an embodiment in which a customer selects and buys a media product within a traditional retail venue; and

FIG. 8 schematically illustrates an embodiment in which a customer preselects and prepays for a media product from a remote client.

### DETAILED DESCRIPTION

The present invention is directed to a unique method of retailing electronic multimedia in a controlled environment utilizing a traditional retail venue, and to a system which enables such a retailing method. Hard and/or portable copies of such multimedia files are generated on demand only at specific retail locations. This retailing method reduces inventory and eliminates stocking costs. Such retail locations would physically contain no pre-recorded media files. Rather, they would comprise one or more local servers located in the retail locations and connected via a network to one or more remote sources of electronic media files. While no pre-recorded electronic media is stored on the local server, it can be downloaded and held in a cache on the local server. From the local server, the media can be saved onto a portable storage medium. Eliminating local storage of the electronic media files increases control over their distribution and maximizes distribution efficiency.

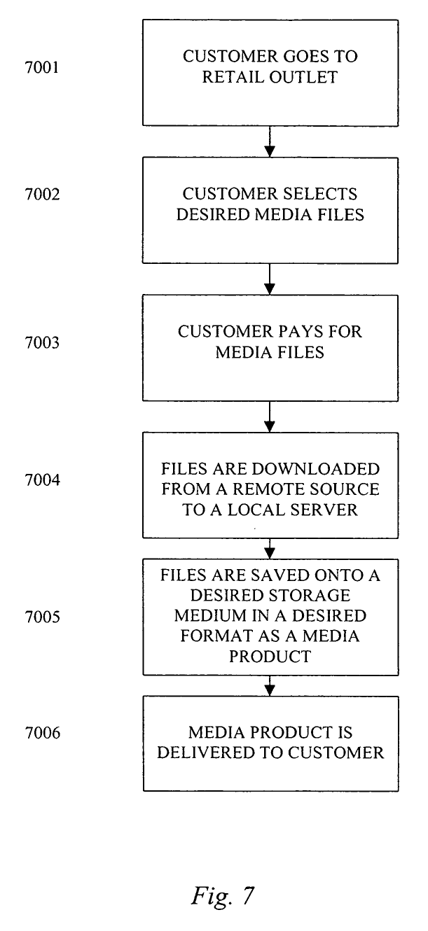

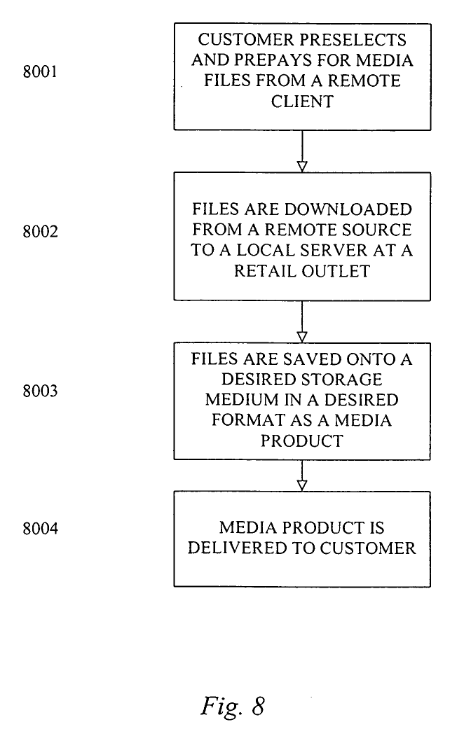

In some embodiments of the present invention, the traditional retail venue (retail site or retail outlet) is a store located within a shopping center or shopping mall. In some embodiments the retail outlet is a stand-alone structure. In some embodiments, the retail outlet is a kiosk, like those found in shopping malls and airports. These embodiments are discussed below (see, for example, FIGS. 7 and 8).

Electronic media files (media files), according to the present invention, may comprise a variety of existing formats which include, but are not limited to, dvd-video, dvd-audio, mp3, mpg, mpeg, wma, wav, avi, pdf, html, xml, wap and combinations thereof. Media files, according to the present invention, can include copyrighted material, freeware, shareware, material within the public domain, and combinations thereof. Essentially any format with associated viewer hardware and software commercially available can be used. Such media files, according to the present invention, include, but are not limited to, images, printed text, video, music, books, movies, magazines, video games, software, newspapers, television shows, and combinations thereof. Essentially any form of audio, visual, or audio/visual media could be sold by the manner put forth in the present invention.

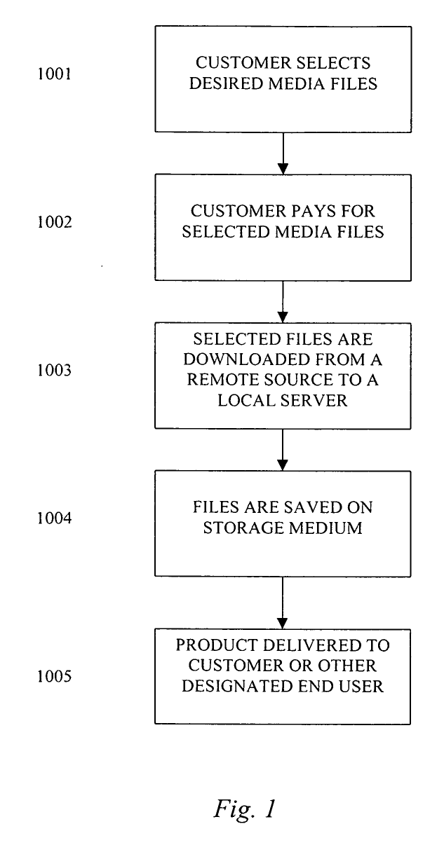

In the most general terms, the retailing method of the present invention comprises a number of steps, illustrated schematically in FIG. 1, whereby a customer selects desired media files (step 1001), customer purchases media files at some point after having selected them (step 1002), selected files are downloaded from a remote source to a local server/controller in a traditional retail venue (step 1003), and selected files are saved on a storage medium (step 1004) and delivered to the customer as a product (step 1005). Note that step 1002 could occur after any of steps 1003-1005. Further note that the process in FIG. 1 is repeatable for a particular customer wanting to purchase more than one product.

To enable such a retailing method as that described above, an enabling system is required. The system generally comprises several modular subsections and is designed to support the method for retailing electronic content without maintaining any pre-prepared inventory, thus eliminating the problems associated with the bulk creation, distribution, storage, and distribution of traditional retailing methods for music (commonly CDs), films (commonly DVDs and VCR tapes), books, still photographs, home movies, and other digitally stored content. The system is designed to be used either locally at the retail location, or in conjunction with home/business computer systems.

The system is configured such that it is inherently easy to expand and upgrade. This allows it to accommodate increased capacity and new delivery technologies and methods which include, but are not limited to, new storage devices and technologies, new end user player devices, new interfaces to approved end user player devices with built-in storage capability, new encryption and content tracking and identification technologies, protection and asset management technologies and techniques, and combinations thereof.

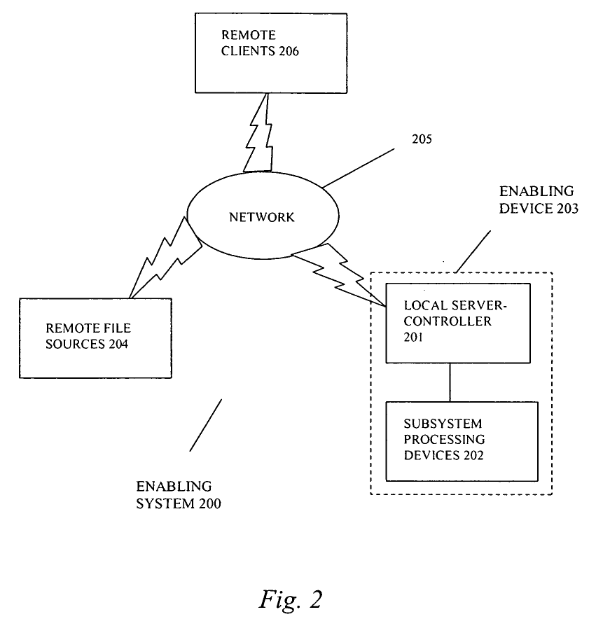

Referring to FIG. 2, an enabling system 200 that enables the electronic retailing method of the present invention generally comprises a local server/controller 201 housed at or within the retail outlet and connected to remote file sources 204 via a network 205. Such a local server/controller 201 comprises the hardware and software necessary to search, locate and retrieve electronic media files, as well as storage, caching, communication interfaces, transaction controls, error and recovery controls and the like. Connected to, and controlled by, the local server/controller 201 are a number of subsystem processing devices 202 capable of generating and delivering a consumer product in accordance with the present invention. Server/controller 201 and subsystem processing devices 202 collectively make up an enabling device 203.

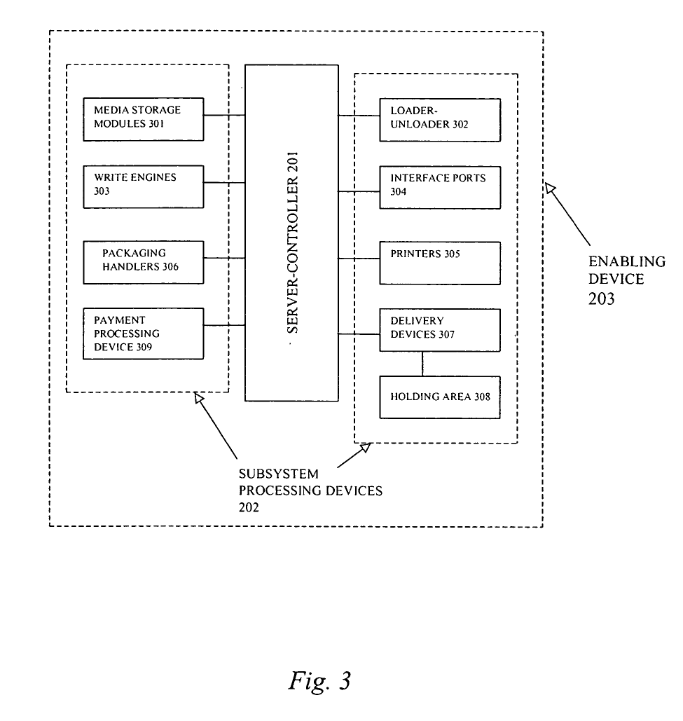

Referring to FIG. 3, the enabling device 203, as part of the enabling system, comprise a local server/controller 201 and subsystem processing devices 202. The subsystem processing devices 202 connected to the local server/controller 201 may comprise any of the following: a local media storage facility (Media Storage Modules) 301 comprised of modules of one or more types of storage media, a mechanical loader/unloader 302 that places new media on and off of media writing/recording (burning) devices 303 called write engines, interface ports 304 that allow content to be directly written to customer owned player devices that have approved format and security capability, printing 305 and packaging handlers 306 that allow the creation of the printed material and any artwork that accompanied the selected source material and places it along with the storage media in an appropriate container, delivery devices 307 allowing for direct delivery of the newly created media to be delivered directly to the customer or to holding areas 308 for distribution to the customer at a later time, and a payment processing device 309 capable of accepting payment by a method selected from the group consisting of credit card, debit card, gift card, cash, other suitable methods of payment, and combinations thereof.

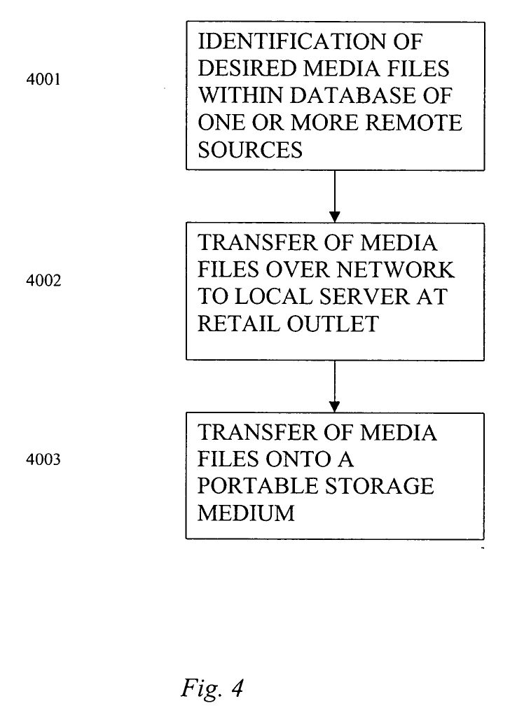

Computer programs, with associated program instructions, are required to identify and manipulate media files, according to the present invention. Referring to the flow diagram in FIG. 4, a computer program(s) enables the identification of desired media file(s) from remote sources (step 4001), the transfer (download) of the media files over a network from the remote source to the local server at a retail outlet (step 4002), and the transfer of the media files onto a portable storage medium (step 4003). Such programs can also enable and perform the associated financial transactions, any necessary packaging and generation of art, copyright protections, and media license tracking.

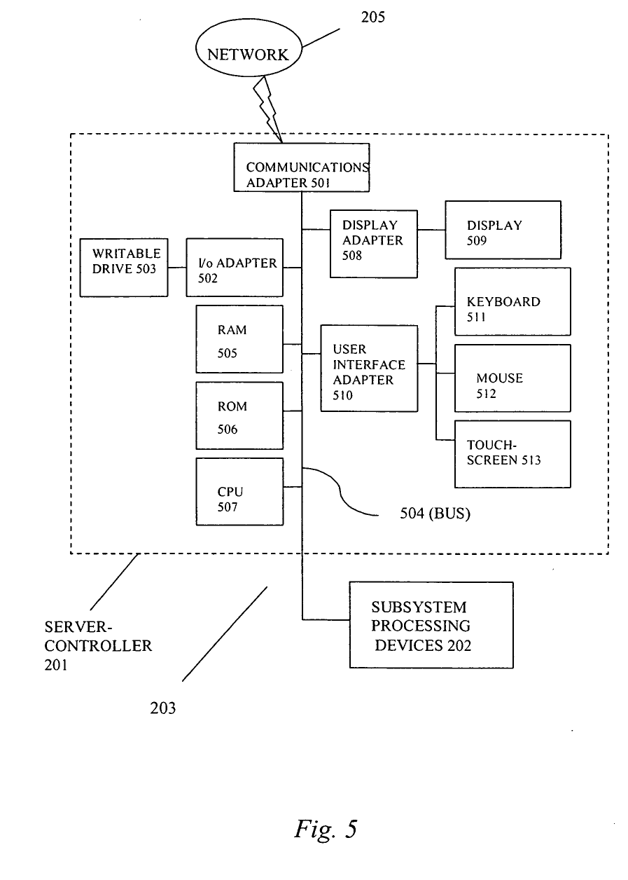

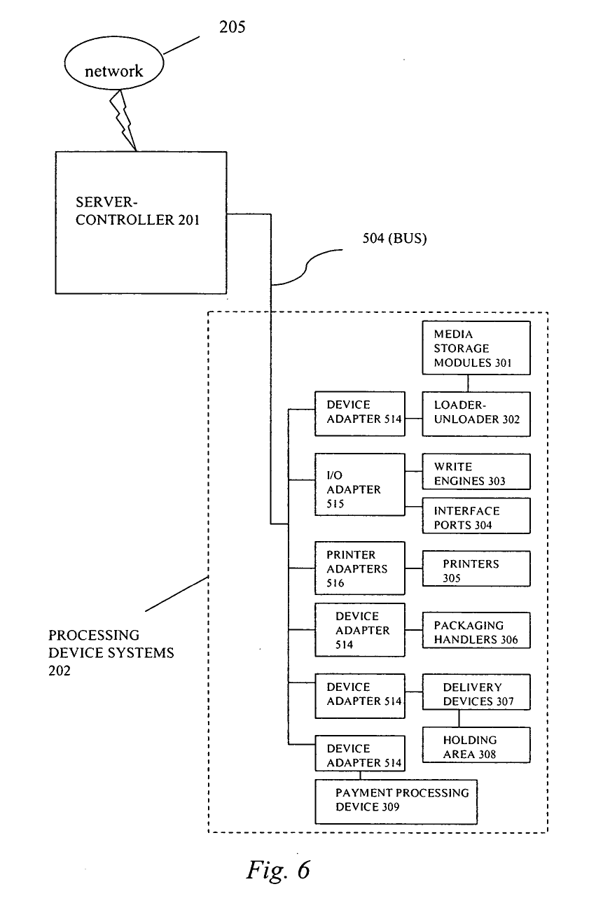

While in some embodiments substantial human intervention may be required to carry out the processes of the present invention, other embodiments are highly automated. Referring to FIG. 5, such automated embodiments can rely on enabling device 203 comprising the local server/controller 201 and one or more subsystem processing devices 202. In such automated embodiments, the local server controller 201 comprises a communications adapter 501 attached to network 205. Connected to the communications adapter 501 via a system bus 504 is a central processing unit 507, ROM 506, RAM 505, an input/output adapter 502 to which is connected a writable drive 503, a display adapter 508 to which is connected a display 509, and a user interface adapter 510 to which are connected user interface devices such as a keyboard 511, a mouse 512, and a touchscreen device 513. Also attached to system bus 504 are various subsystem processing devices 202 along with associated device adapters. Referring to FIG. 6, an input/output adapter 515 permits control of write engines 303 and interface ports 304. A printer adapter 516 permits system printing from printer 305. Various device adapters 514 permit control of the mechanical loader/unloader 302, the delivery devices 307, and the packaging handlers 306, ultimately allowing for the product to be transported to a holding area 308. In some embodiments, a payment processing device 309 is included as a subsystem processing device.

Referring to FIG. 7, in some embodiments of the present invention, a customer goes to such a retail location (step 7001), selects media files in the format he wishes to purchase (step 7002), pays for the files at some point after having made his selection (step 7003), the files are downloaded from a remote source to a local server (step 7004) and stored in cache memory from where they are saved onto a storage medium (step 7005) and delivered to the customer (step 7006). Referring to FIG. 8, in other embodiments, a customer can pre-select and pre-pay for electronic media files from an internet terminal (remote client 206) (step 8001). Following step 8001, the files are downloaded from a remote source to a local server (step 8002) and then saved onto a desired storage medium in a desired format as a media product (step 8003). The customer can then go to the retail outlet to pick up his purchase or have his purchase delivered to himself or other person of his choosing (end user) (step 8004). These internet terminals can be located in a house, a place of business, or another traditional retail outlet. Such later embodiments are particularly advantageous when the files are very large (e.g., movies) and require substantial download time—even over high-speed network connections.

Selection of files by the customer can be accomplished in a variety of ways. Selection of media files can be from a list of titles, a searchable database, or combinations of the two. Such titles can have associated with them a number. In some embodiments this merely entails articulating the selections (e.g., identified from a list) to an attendant. In other embodiments, the process is more self-serve, wherein the customer may select the files from a touch screen menu or other menu-driven or computer-driven process. In some embodiments, the selection process comprises a step of placing file titles in a virtual “shopping cart.”

In some embodiments, especially those in which download times are more than a few minutes in duration (as might be the case for movies), customers may be provided with a receipt with which they can collect their media product after a given amount of time.

In some embodiments of the present invention, the customer completes a financial transaction (i.e., pays) by a method selected from the group consisting of credit card, cash, bank transfer, check, money order, and combinations thereof.

In some embodiments, data processing software used to manage file selection and downloads is also used to track sales of copyrighted material by artist, record label, title, etc., as might be required by various licensing agreements. Such a method facilitates the legal transfer of said files. Such data processing software can also be used to copyright-protect the electronic media files. In some embodiments, the media products sold to customers comprise electronic media files that are single-play or which possess a finite access lifetime.

According to the present invention, the local servers located within the retail outlet are connected to one or more remote file sources via a network. Such a network may be implemented in a variety of network systems applications, including Internet, intranet, cable based, hybrid Internet-cable systems, wide area networks, local area networks, and combinations thereof.

According to the present invention, selected files may be downloaded from a remote source to cache memory in the local server within the retail outlet. This cache does not permanently store the media files, but merely serves to hold them for such a time that they can be saved onto storage media by a media recorder. As the cache fills, the files are deleted in a queued fashion. This enhances the ability to control and track the distribution of said media, and it eliminates the need to have large amounts of storage space at the individual retail outlets. This latter aspect is particularly important when dealing with very large electronic media files (e.g., feature-length movies).

In some embodiments, depending on the size of the cache and the frequency of a particular file download, electronic media files may remain in the local server's cache memory indefinitely. This is likely to be the case primarily for bestsellers.

Media storage, according to the present invention, can be any storage medium that can suitably store media files as defined herein. Examples of such storage media include, but are not limited to, CD-ROM, DVD-ROM, floppy disks, DataPlay™ disks, SmartMedia™, Zip® disks, media sticks, USB memory keys, portable mp3 players, printed pages, video cassettes, and combinations thereof.

In some embodiments, the media is in a compressed file format. A variety of commercially-available compression programs presently exist to effect such compression/decompression of electronic media files. Thus, in some embodiments, the media files are stored as compressed files in the central server database and decompressed prior to delivery to the customer, whereas in other embodiments the media files are sold to the customer in a compressed format.

### EXAMPLES

The following examples are included to demonstrate particular embodiments of the present invention. It should be appreciated by those of skill in the art that the methods disclosed in the examples which follow merely represent exemplary embodiments of the present invention. However, those of skill in the art should, in light of the present disclosure, appreciate that many changes can be made in the specific embodiments described and still obtain a like or similar result without departing from the spirit and scope of the present invention.

Examples 1-4 illustrate various scenarios in which a customer might purchase a media product in a manner which falls within the scope of the present invention.

### Example 1

A customer arrives at a retail outlet where the present invention is located (e.g., a kiosk in a retail store) and desirous of obtaining a custom music compilation on a compact disk (CD). Customer selects from a display screen a number of music files from a list and directs the local system device to download said files in a desired format (e.g., CD-audio). Customer is prompted to insert a credit card to pre-pay for selections requested. Customer complies and the system begins the download process from a remote library of electronic media files to a local server at the retail outlet where the files are temporarily stored in a cache. The system device then records these files onto a CD in an arrangement favorable to the customer and might even create a customized label and jewel case. The customer then receives his customized CD and departs the retail outlet.

### Example 2

A customer desirous of obtaining a hard-to-find movie on a DVD in DVD-video format arrives at the retail venue. The customer searches a list and finds an identification number for the movie he wants. Customer presents an attendant at the retail venue with the number and the attendant locates and downloads the appropriate file from a central server to a computer terminal at the retail venue where it is stored in a cache. The attendant gives the customer a receipt and tells him that his movie will be ready after a certain time. Customer then pays for movie and leaves. Attendant proceeds to process customer's request by entering instructions into the system device. The system device then produces the customer's DVD. After a specified time period, customer returns to the retail venue and picks up his movie, presented to him in a customized DVD case.

### Example 3

A customer desirous of obtaining a rare out-of-print book arrives at a retail outlet in a shopping mall. An attendant directs customer to a self-serve touch screen computer terminal where he searches a list for the out-of-print book. Customer locates and downloads the book in a suitable file format to the computer terminal's cache. Through a series of touch screen commands, customer has the device record the file on a CD. The cache is automatically emptied and the customer optionally creates a label and jewel case for his media product. Customer is then given a receipt which he takes to a check-out counter (along with his CD) and pays. In similar embodiments, customer has the out-of-print book printed on paper, of suitable size and weight, and then has it bound into a traditional book format with a customized label.

### Example 4

A customer desirous of obtaining a hard-to-find feature-length movie in DVD format connects, via the Internet, to a local server in a retail outlet from his home personal computer. He searches and finds the desired movie title, selects DVD format, and indicates which store location he will pick it up at. He pre-pays by credit card, receives a printable electronic receipt, and is given a time after which his purchase will be available for pickup. After such time, he drives to the specified retail outlet where he presents his receipt to an attendant who retrieves the DVD, in packaged form, from a holding bin.

### Example 5

This example serves to illustrate how the retailing method of the present invention is integrated with the enabling system.

Referring to FIGS. 2, 3, 5 and 6, at each retail location, a local server/controller 201 receives requests for specific content (media files) from user/purchasers either through local client computing systems at the retail site, or through remote client computers 206 connected to the local server through the Internet. This not only enables the creation of unique collections or compilations of various media (e.g., customized albums) that contain selections tailored to the interests or needs of a particular customer/end user, but also allows for pre-selected collections or compilations to be created by artists, producers, recording labels, content distributors, etc. As the particular media content is selected, the local server/controller 201 will determine if the specific item(s) (files) is currently cached at the server/controller 201, or if it must be downloaded from remote library sites 204 via high speed access provided over public or private networks 205. If not already locally cached, the download process to the local server 201 will begin immediately. The end user/customer would select the desired storage medium type and format, as well as requesting immediate or delayed production of the collection (product). At the point in time when the end user/customer concludes the transaction and payment is confirmed, the local server will cause the desired storage medium type to be taken from the media storage module 301 by the mechanical loader/unloader 302 and placed in the appropriate write engine (burner) 303 for the desired storage medium type and format. The local server/controller 201 will then cause the transfer of the content (media files) that was selected by the end user/customer to the selected storage medium via the write engine 303 and verify that it has been correctly written onto the storage medium with appropriate security and tracking information. If the end user/customer has selected to write directly to an approved personal player device, the above steps of selecting, loading, and writing will be bypassed, and the local server/controller will allow an interface port 304 to be directly accessed by the end user/customer and cause a direct write to the customer's approved device (i.e., mp3 player, etc.). The system will optionally print appropriate cover artwork and information listing artists, authors, composers, producers, etc., as necessary. The mechanical loader/unloader 302 will transfer the completed media product to a packaging module 306 that will combine the artwork and printed materials with the media and wrap the collection in an appropriate container for delivery to the customer, unless the customer has chosen to use his own approved player, in which case the information will be placed electronically on the player device. For local transactions that can be completed in less than a few minutes (time defined by the local retailer) and transfers to end user/customer devices, the customer can receive his completed purchase directly from the system delivery tray. For remote, delayed, or long transactions (i.e., DVD films), the system will label the finished, purchased package and place it in a holding area 308 reserved for pickup by the customer at a later time.

### Example 6

This example serves to illustrate how methods of the present invention can be carried out with a retailing device.

A device comprising a server/controller and various subsystem processing devices is located in a grocery store (or any traditional retail venue) and is connected to the Internet via a high-speed connection (T1, cable, DSL, etc.). A customer in the store goes up to the device and via a touch-screen menu searches for a song by artist and file type. Song is located on a particular remote source and song is then placed in a virtual shopping cart. Customer repeats process for an additional 50 songs, each song being added to the shopping cart. Customer then selects the media type he wishes his product delivered on: a CD. Customer then inserts his credit card into a card reader of the device and the device processes the transaction. The device then downloads all 51 songs into its cache memory, automatically selects a blank CD from a media storage module within one of its subsections and automatically inserts the blank CD into a write engine. Files are then saved onto one or more CDs and the CD(s) is (are) automatically removed from the write engine, placed in or with a jewel box(es), cover art is printed and maybe inserted, the media product is optionally shrinkwrapped, and the wrapped media product is presented to the customer.

Although the present invention and its advantages have been described in detail, it should be understood that various changes, substitutions and alterations can be made herein without departing from the spirit and scope of the invention as defined by the appended claims.

1. A method comprising the steps of
a) receiving, at a retail venue, selections of media files from a customer;
b) receiving, from the customer, payment for selected media files;
c) downloading electronic media files pertaining to said selections of media files from at least one remote source to a local server within said retail venue;
d) saving the electronic media files on a storage medium as a portable media product; and
e) delivering the portable media product to a designated end user.

2. The method of claim 1, wherein the customer preselects the media files and prepays from a remote client.

3. The method of claim 2, wherein the remote client is a computer connected to the Internet.

4. The method of claim 1, wherein the retail venue is selected from the group consisting of a store within a shopping mall, a store within a shopping center, a stand-alone retail outlet, a kiosk within a public place, and combinations thereof.

5. The method of claim 1, wherein the electronic media files comprise media selected from the group consisting of music, printed text, video, instructional programming, television shows, images, audio books, movies, games, software, newspapers, magazines, and combinations thereof.

6. The method of claim 1, wherein customers select media files from a searchable list.

7. The method of claim 1, wherein the network is selected from the group consisting of Internet based, intranet based, wide area networks, local area networks, and combinations thereof.

8. The method of claim 1, wherein the electronic media files are stored on storage media selected from the group consisting of CD-ROM, DVD-ROM, floppy disks, SmartMedia™, Zip® disks, media sticks, USB memory keys, DataPlay™, portable mp3 players, and combinations thereof.

9. The method of claim 1, wherein the electronic media files are temporarily held in a queued fashion in a cache on the local server within said retail venue and discarded as the cache fills up.

10. The method of claim 1, wherein payment is made by a method selected from the group consisting of credit card, cash, bank transfer, check, money order, and combinations thereof.

11. The method of claim 1, wherein the electronic media files are compressed.

12. The method of claim 1, wherein the electronic media files are single-play.

13. The method of claim 1, wherein said method is an automated, self-serve operation.

14. A system comprising:
a) a traditional retail outlet; and
b) a device comprising:
i.) a local server/controller connected to remote sources of electronic media files via a network; and
ii.) at least one subsystem processing device capable of generating a commercial media product.

15. The system of claim 14, wherein the at least one subsystem processing device is selected from the group consisting of delivery devices, write engines, mechanical loaders/unloaders, interface ports, printers, packaging handlers, and combinations thereof.

16. The system of claim 14, wherein the network is selected from the group consisting of Internet, intranet, cable based, hybrid Internet-cable systems, wide area networks, local area networks, and combinations thereof.

17. The system of claim 14, further comprising a touch-screen interface.

18. The system of claim 14, further comprising a payment processing device capable of accepting payment in a form selected from the group consisting of cash, credit card, debit card, bank transfer, and combinations thereof.

19. The system of claim 14, wherein the system is self-serve.

20. The system of claim 14, wherein the device is automated.

21. The system of claim 14, further comprising at least one remote client.

22. The system of claim 21, wherein the at least one remote client is connected to the system via the Internet.

23. The system of claim 21, wherein media files are selected via the at least one remote client.

24. The system of claim 21, wherein media files are purchased via the at least one remote client.

25. A retailing device comprising:
a) a local server/controller connected to remote sources of electronic media files via a network; and
b) at least one subsystem processing device capable of generating a commercial media product.

26. The retailing device of claim 25, wherein the device is physically located within the confines of a traditional retail venue.

27. The retailing device of claim 25, wherein the at least one subsystem processing device is selected from the group consisting of delivery devices, write engines, mechanical loaders/unloaders, interface ports, printers, packaging handlers, and combinations thereof.

28. The retailing device of claim 25, wherein the subsystem processing devices are controlled by the server/controller.

29. The retailing device of claim 25, wherein the server/controller can receive commands via remote clients over a network.

30. The retailing device of claim 25, further comprising a subsystem device which accepts payment for the commercial media product.

31. An integrated computer program comprising:
a) program instructions for searching for electronic media files on remote file sources;
b) program instructions for processing payment transactions;
c) program instructions for downloading electronic media files from remote file sources to cache memory within a local server/controller; and
d) program instructions for saving the electronic media on a storage medium.

32. The integrated computer program of claim 31, wherein payment transactions involve a method of payment selected from the group consisting of cash, debit card, credit card, and combinations thereof.

33. The integrated computer program of claim 31, further comprising:
a) program instructions for selecting a desired storage medium and transferring the storage medium from media storage modules to a write engine;
b) program instructions for printing accompanying art; and
c) program instructions to handle packaging.

34. A method comprising the steps of
a) receiving, at a retail venue, selections of media files from a customer;
b) receiving, from the customer, payment for selected media files;
c) loading electronic media files pertaining to said selections of media files from at least one source;
d) saving the electronic media files on a storage medium as a portable media product; and
e) delivering the portable media product to a designated end user.
